(19) United States
(12) Patent Application Publication
(10) Pub. No.: US 2023/0015309 A1
(43) Pub. Date: Jan. 19, 2023

(54) METAL REINFORCED BOARD

(71) Applicant: IKEA Supply AG, Pratteln (CH)

(72) Inventor: Håkan KÄLL, Älmhult (SE)

(73) Assignee: IKEA Supply AG, Pratteln (CH)

(21) Appl. No.: 17/782,022

(22) PCT Filed: Dec. 8, 2020
(86) PCT No.: PCT/EP2020/085123

§ 371 Date: Jun. 2, 2022

(30) Foreign Application Priority Data
Dec. 17, 2019 (SE) 1951475-1

(51) Int. Cl. E04C 2/34; B32B 3/06; B32B 3/30; B32B 3/08; B32B 3/12; B32B 3/18; B32B 7/08; B32B 7/12; B32B 15/10; B32B 21/02; B32B 21/06; E04C 2/28; E04C 2/38

(52) U.S. Cl. CPC E04C 2/3405; B32B 3/06; B32B 3/30; B32B 3/08; B32B 3/12; B32B 3/18; B32B 7/08; B32B 7/12; B32B 15/10; B32B 21/02; B32B 21/06; E04C 2/28; E04C 2/384; B32B 2479/00; E04C 2002/3488

(57) ABSTRACT

The invention relates to a hollow board material comprising a first sheet and a second sheet. A first and a second lath are arranged in parallel between the first sheet and the second sheet along opposite edges of the hollow board material. The first lath and the first sheet are attached to each other by means of a first metal gripping lamina which at least partly covers the first lath. The second lath and the first sheet are attached to each other by means of a second metal gripping lamina which at least partly covers the first lath. Optionally, the first lath and the second sheet are attached to each other by means of a third metal gripping lamina and optionally the second lath and the second sheet are attached to each other by means of a fourth metal gripping lamina. The metal gripping laminas have a first face and a second face which are opposed to each other. Each face comprises a plurality of sharp projections extending substantially perpendicular therefrom and into the laths or the sheets respectively. The metal gripping laminas thereby provides a hollow board material and increases the bending strength of the hollow board material. The invention further relates to a furniture comprising said hollow board material and method for producing said hollow board material.

### FIELD OF THE INVENTION

The present invention relates to a composite hollow board material. Further, the invention relates to a furniture comprising said hollow board material and a method for manufacturing said hollow board material.

### BACKGROUND

In the field of furniture, it is common practice to manufacture various composite hollow board materials, which subsequently may become a part of a piece of furniture.

Composite hollow board materials typically comprise two sheets of material having an intermediate distance material arranged in between said sheets. Such composite hollow board materials, compared to solid board materials or wood, provides a lightweight and relatively strong material. An examples of such material is disclosed

WO 2010/069994. The manufacturing of some composite hollow board materials is well known, and continuous manufacturing of such boards is disclosed in for instance WO 2012/048738.

A basic description of the production of a composite hollow board material comprises the positioning of laths parallel to each other on one glue coated flat side of the first sheet, filling the spaces between the laths with the distance material, such as honeycomb of cardboard, plastics or the like, or with foam plastic material, of approximately the same height as the laths, and then arranging the second glue coated second sheet on top of the laths and the distance material. The formed unit is then compressed and glued together.

However, in humid conditions, glues have the drawback of decreasing adhesiveness. This will affect the bending strength as well as the resistance to delamination of the hollow board. The sheets of the board may eventually separate from the laths and the distance material due to loss of adhesion. In addition, alterations in humidity may cause the hollow board to become deformed and curled. Hence, the composite hollow board is not sustainable in humid environments. Further, composite hollow boards are sensitive to humidity variations. Furthermore, if the hollow board material is a part of a furniture, the furniture will most likely become discarded and a new furniture has to be purchased.

In addition, even though the adhesion of the sheets to the distance material and the laths provides at least some stability to the structure, the strength and stiffness of the board is affected in a humid climate. Further, when moisture affects the rigidity, there is a risk that the board will collapse and that the furniture in which the board is present is damaged.

Thus, there is a need for an improved composite hollow board material having properties withstanding moisture variations and having improved rigidity and strength.

### SUMMARY

The hollow board material disclosed herein is—inter alia—based on the idea that a metal gripping lamina can substitute an adhesive to attach parts of the hollow board material to each other. As described, adhesives suffer from several drawbacks when used in hollow board materials. The present inventors have surprisingly found that adhesives can be replaced by a metal gripping lamina, which withstands humid climates, as well as variations in humidity, and provides better strength to the hollow board material. Thus, a hollow board material sustaining high moisture environments and which has an improved rigidity is obtained.

Consequently, the present invention seeks to mitigate, alleviate, eliminate or circumvent one or more of the above identified deficiencies in the art and disadvantages singly or in any combination by, according to a first aspect, providing a hollow board material comprising a first sheet and a second sheet. A first and a second lath are arranged in parallel between the first sheet and the second sheet along opposite edges of the hollow board material. The first lath and the first sheet are attached to each other by means of a first metal gripping lamina, which at least partly covers the first lath. The second lath and the first sheet are attached to each other by means of a second metal gripping lamina, which at least partly covers the first lath. Optionally, also the first lath and the second sheet are attached to each other by means of a third metal gripping lamina and optionally the second lath and the second sheet are attached to each other by means of a fourth metal gripping lamina.

The metal gripping laminas have a first face and a second face, which are opposed to each other. Each face comprises a plurality of sharp projections extending substantially perpendicular therefrom and into the laths or the sheets respectively. The metal gripping laminas thereby provides a hollow board material and increases the bending strength as well as de-lamination strength of the hollow board material.

Using of the metal gripping lamina instead of a conventional adhesive provides improved strength and solidity to the hollow board material. The obtained hollow board material has improved rigidity and stability. These improvements enable the board to withstand humid environments without disintegrating. In addition, the use of toxic or non-environmentally friendly chemicals, such as a glue, is sufficiently decreased.

Further, in the hollow board material disclosed herein, the metal gripping lamina provides such rigidity and stability, without the need for glue. The sharp projections on the metal gripping lamina connects the laths and sheets together, whereby the use of chemicals can be decreased in the hollow board material. While adhesives suitable for metal are available, they typically require a metal surface essentially free from oxides. Thus, the metal surface has to be treated in line, as the time frame for the application of a metal to the metal glue is narrow. Further, the metal surface has to be essentially clean. It is an advantage to be able to introduce a supporting metal lamina into the hollow board material to improve its structural integrity and at the same time dispensing with the need for an adhesive. In addition, there is no need for cleaning the metal surface since oil residues or oxides, e.g. rust, will not affect the formation of the hollow board material disclosed herein.

The sharp projections of the gripping lamina may be arranged in rows on the first and second faces. In one embodiment, the sharp projections are gouged from the first and second face of the metal gripping laminas. The sharp projections in rows adjacent to each other may be gouged from opposite angles and the sharp projections are gouged parallel to the longitudinal extension of the metal gripping lamina. This is advantageous during the manufacturing of the sharp projections. The gouging from two opposite directions at the same time results in even power distribution during the manufacturing of the metal gripping lamina.

In another embodiment, a height (H) of the sharp projections is smaller than a thickness (T) of the first and second sheets. This prevents the sharp projections from penetrating a face of the sheets, which do not face the metal gripping lamina.

The metal gripping lamina may be made of steel or aluminium. Further, the metal gripping lamina may be between 0.2 mm and 3 mm thick, such as 0.5 and 2 mm thick. The thickness is sufficiently high to provide desired stability. The properties, such as low density, of steel and aluminium are advantageous.

In one embodiment, the first and second sheets comprise lignocellulosic fibres, and/or the first and second laths comprise lignocellulosic fibres.

The first and second sheets may be sheets of a particle board, or a fibreboard (e.g. MDF or HDF). Preferably, the first and second sheets are sheets of MDF. The first and second laths may be laths of a chip board, a particle board, or a fibreboard (e.g. MDF or HDF). Preferably, the first and second laths are laths made of particle board. In one embodiment, the hollow board material further comprises a third lath and a fourth lath arranged perpendicular to the first lath and second lath, along edges of the first and second sheets, whereby the first, second, third and fourth laths form a frame surrounding the edges of the hollow board material. The third and fourth laths may be of the same material as the first lath and the second lath.

In another embodiment, the hollow board material comprises a distance member being arranged between and attached to the first sheet and the second sheet.

The distance member may comprise lignocellulosic fibres.

The distance member may be a distance member of a paperboard (e.g. cardboard), a particle board, a plastic, or a fibreboard (e.g. MDF or HDF). Preferably, the distance member is a distance member of cardboard.

The distance material may be strips arranged perpendicular to the extension of the first and second sheets. Preferably, the strips are arranged in a meandering pattern or as a honeycomb structure, and the strips are attached to the first and second sheet by means of an adhesive. If arranged as a honeycomb structure, the strips may be attached to each other as well. They may be attached to each other by an adhesive.

In one embodiment, at least one lath is provided with a recess in which the metal gripping lamina is arranged. This is advantageous since it allows for attachment of the lath to the sheets using both the metal gripping element and an adhesive.

In a second aspect, there is provided a furniture comprising the hollow board material described herein above. Due to the use of the hollow board material, such furniture will be lighter than the same furniture made of solid materials, while at the same time being able to withstand humid climates. The hollow board material prevents bending and deflection when exposed to humidity variations and/or humid conditions.

In a third aspect, there is provided a method for manufacturing a hollow board material. The method comprises the steps of arranging two laths in parallel to each other on a first sheet, such that the laths extend along two opposite edges of the first sheet. The metal gripping laminas are arranged between the two laths and the first sheet. The method further comprises arranging a second sheet on the laths. Optionally, the metal gripping laminas are arranged between the two laths and the second sheet. In addition, the method comprises applying a pressure along the edges of the hollow board member where the laths are arranged, whereby the metal gripping lamina(s) securely fasten the laths and the sheets together.

This method is advantageous since it is an easy and a quick process. Further, there is no need for toxic or hazardous adhesives or chemicals. The method is cheap and there the obtained hollow board material has improved properties compared to those hollow board materials produced using adhesives for assembly.

In one embodiment, the method further comprises that, before the step of arranging a second sheet on the laths, a distance material is placed in between the two laths.

In another embodiment, after the step of applying a pressure along the edges of the hollow board member where the laths are arranged, at least one edge band is attached to an edge of the hollow board material. Preferably, the edge band is attached using an adhesive.

Further advantageous features of the invention are elaborated in embodiments disclosed herein. In addition, advantageous features of the invention are defined in the dependent claims.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 depicts a hollow board material;

FIG. 2a shows a cross section of the hollow board material depicted in FIG. 1;

FIG. 2b shows another cross section of the hollow board material depicted in FIG. 1;

FIG. 3a shows one surface of a metal gripping lamina;

FIG. 3b shows an enlarged view of a metal gripping lamina;

FIG. 3c shows a schematic illustration of the formation of a sharp protrusion on the metal gripping lamina shown in FIGS. 3a and 3b;

FIG. 3d shows a schematic illustration of a curved sharp protrusion;

FIG. 3e shows a schematic illustration of an even further curved sharp protrusion;

FIG. 4 shows part of a cross section of a board material according to an embodiment; and

FIG. 5 shows part of a cross section of a hollow board material according to an embodiment.

### DETAILED EMBODIMENTS

Hereinafter, certain embodiments will be described more fully with reference to the accompanying drawings. The invention may, however, be embodied in many different forms and should not be construed as limited to the embodiments set forth herein. Rather, these embodiments are provided by way of example so that this disclosure will be thorough and complete, and will fully convey the scope of the invention, such as it is defined in the appended claims, to those skilled in the art.

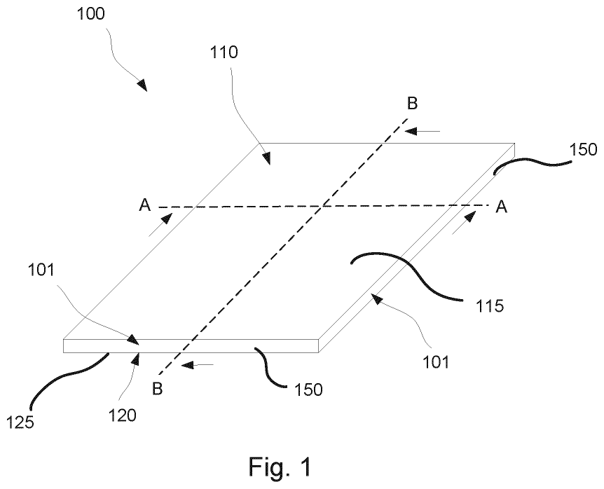

With reference to FIG. 1, a hollow board material 100 is shown, which comprises a first sheet 110 and a second sheet 120. Faces 115, 125 of the first and second sheet are also referred to herein as a first board surface 115 and as a second board surface 125, respectively. The hollow board material has edge band(s) 150 arranged on edges 101 of the hollow board member 100.

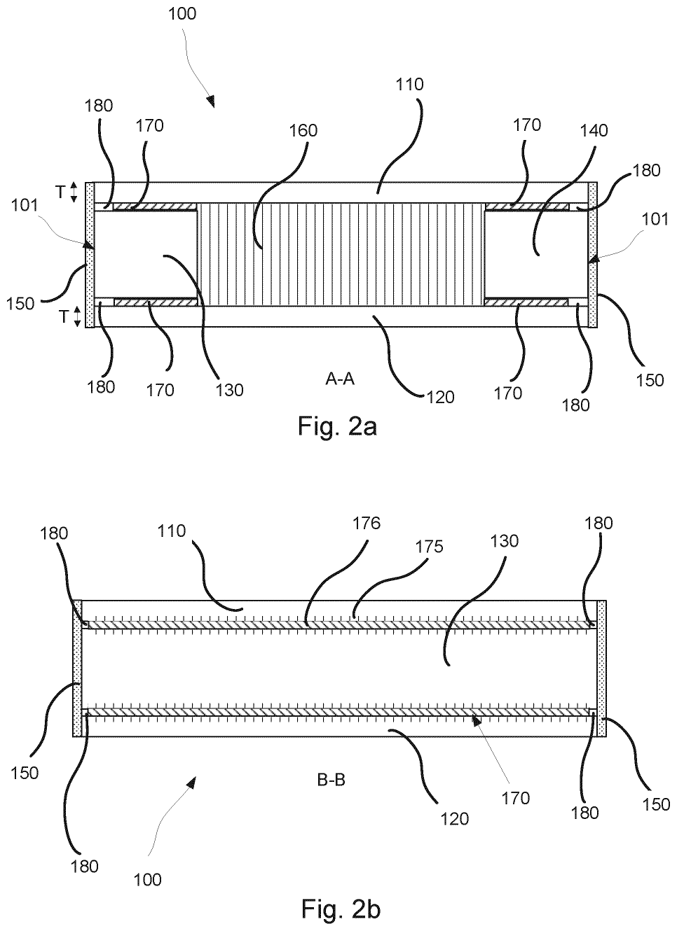

FIG. 2a shows a side view of section A-A of the hollow board material 100 in FIG. 1. The hollow board material 100 shown in FIG. 2a comprises a first lath 130 and a second lath 140 arranged in parallel along two opposite edges of the hollow board material 100. The first and second lath 130, 140 may also be referred to as the first and second stile. A distance material 160 is arranged in between the laths and the board faces. The distance material 160 may be adhered to the board surfaces using an adhesive, such as a glue (not shown).

The first and second sheets 110, 120 may for instance be made of a material selected from a particle board, or fibreboard (e.g. medium density fibre (MDF) board, or high density fibre (HDF) board). Preferably, the first and second sheets 110, 120 are sheets of HDF.

The first and second laths 130, 140 may for instance be made of a material selected from a particle board, chip board, or a fibreboard (e.g. MDF, or HDF). Preferably, the first and second laths 130, 140 are made of particle board.

The distance member 160 may for instance be made of a material selected from a paper board, a plastic material (e.g. a foam plastic material), a particle board, or a fibreboard (e.g. MDF, or HDF). Preferably, the distance member 160 is made of a paper board, such as card board. Further, the distance material may be arranged as a honeycomb structure (not shown). According to an embodiment, the distance material arranged as a honeycomb structure comprises paper board, such as card board. According to an alternative embodiment the honeycomb structure is formed from a plastic or the like.

Further, the hollow board material 100 in FIG. 2a comprises metal gripping laminas 170. The metal gripping laminas 170 are arranged between the laths 130, 140 and the first and second sheets 110, 120 and is configured to attach the laths 130, 140 and the sheets 110, 120 to each other. As indicated in FIG. 2a, the first and second sheet 110, 120 have a thickness “T”.

According to an embodiment, the metal gripping laminas 170 in FIG. 2a are arranged at a distance from the edge band(s) 150, indicated by a space 180. Before attaching the edge band(s) 150, the edges 101 of the hollow board material 100 may be cut to provide the desired edge shape, such as a perpendicular edge or a rounded edge. When arranging the metal gripping laminas 170 with a space 180 from the edges 101 of the hollow board material 100, there is no need for metal cutting tools or the use of excess metal materials.

FIG. 2b shows a side view of section B-B of the hollow board material 100 in FIG. 1. The lath 130 is attached to the first and second sheet 110, 120 through the metal gripping laminas 170, by means of sharp projections 175 extending from a double-faced metal plate 176 into the lath 130 and the sheets 110, 120, respectively. The edge band(s) 150 cover the edge(s) 101 of the hollow board material 100.

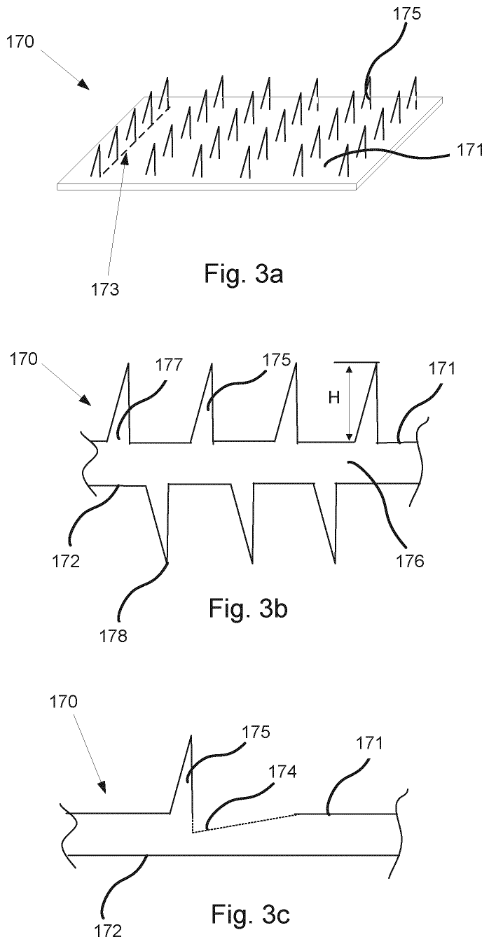

An example of a metal gripping lamina is disclosed in US 2018/0257332 A1. An example of the use of a metal gripping lamina in a hollow core composite board is disclosed in US2016176152 A1. In present FIGS. 3a and 3b, the metal gripping lamina 170 is shown in detail. In FIG. 3a, the sharp protrusions 175 are aligned in a plurality of rows 173 on a first face 171 of the metal gripping lamina 170. The left outermost rows 173 is indicated by a dashed line.

As seen in FIG. 3b, the metal gripping lamina 170 is in the form of a double-faced metal plate 176, comprising a plurality of extending protrusions 175, such as sharp projections, arranged on both the first face 171 and the second face 172 of the metal gipping lamina 170. The sharp projections 175 extend substantially perpendicular from the faces 171, 172. The sharp projections 175 are arranged in rows on the faces 171, 172. Preferably, the sharp projections 175 in rows adjacent to each other are arranged such that the sharp projections 175 initially extends from the metals plate 176 in opposite directions. Preferably, the same number of sharp projections 175 are extending in each opposite direction. Hence, if a number of sharp projections 175 are extending in one direction on the first face 171, essentially the same number of sharp projections 175 are extending in the opposite direction on the first face 171. This also applies to the second face 172. However, the first face 171 may comprise a lower or larger number of sharp projections 175 in total compared to the second face 172.

Alternatively, the sharp projections are arranged in rows with a distance D between each sharp projection 175, and each sharp projection 175 in the adjacent row(s) is (are) displaced by approximately half the distance D in the direction of the row.

Further optionally, the sharp projections 175 are arranged in rows and rows are groups into groups of two rows adjacent to each other, and where the sharp projections 175 in these two rows in the same group extend from the metal plate 176 in the same direction, while the groups adjacent thereto comprise sharp projections 175 extending from the metal plate 176 in opposite directions. Hence, the metal plate 176 may comprise sharp projections 175 arranged in rows, wherein two rows of sharp projections 175 have been gouged from the same direction, followed by two rows of sharp projections 175 having been gouged from an opposite direction. This structure can be repeated to form a metal gripping lamina 170.

Generally, the sharp projections 175 extends perpendicular to the baseplate 176 as they are bent. Sharp projections 175 pointing in opposite directions enhances the power distribution throughout the surface where the material gripping lamina 170 connects the laths 130, 140 and sheets 110, 120 together. The metal gripping lamina 170 is preferably made from a steel or aluminium.

Optionally, bases of the sharp projections 175 of the metal gripping lamina 170 may be oriented perpendicularly along the extension of the laths 130, 140. This provides a de-lamination strength in the same range as if the bases of the sharp projections 175 are oriented in parallel with the extension of the laths 130, 140, but it improves compressive and tensile strength. As shown in FIG. 3b, the sharp projections 175 have a height “H”. The dimension of the height H is smaller than the thickness T of the first and second sheets 110, 120 to prevent the projections 175 from penetrating the outward facing surface 115, 125 of the first and second sheets 110, 120 when the hollow board material 100 is formed.

A thickness of a base 177 of the sharp projections 175 adjacent to the face of the metal gripping lamina 170 is preferably larger than the thickness of a tip 178 of the projection 175. Hence, the thickness is tapered such that the base 177 has the greatest thickness and is closest to the face of the metal gripping lamina 170. The tapered shape of the sharp protrusions 175 can schematically be seen in FIGS. 3a, 3b and 3c. Further, also the width of the projection 175 may be tapered (not shown). Optionally, the sharp projections 175 have a linear shape, having the same thickness and width from the base 177 to the tip 178.

The formation of the sharp projections 175 on the metal gripping lamina 170 is illustrated in FIG. 3c. Preferably, the sharp projections 175 are manufactured by actuating a cutting tool (not shown), e.g. a chisel with a concavo-convex cross section, to impact the first 171 and second face 172 of the metal gripping lamina 170. To produce a sharp projection 175, the cutting tool impacts the first 171 or second 172 face and moves across said face 171, 172, gouging and/or milling a groove 174 into said face. Dashed lines in the metal gripping lamina 170 in FIG. 3c indicate the formed groove 174. The sharp projection 175 is then formed from the part of the material released when creating the groove 174 by bending it upwards out of the groove 174. Hence, the term gouging, as recognised by the skilled person, means that the sharp projections 175 are formed by a cut from the first or second face 171, 172 of the metal gripping lamina 170 itself creating a pointed structure, which is subsequently bent upwards from a formed recess 174 in the metal gripping lamina 170. Optionally, the first and second sheets 110, 120, the first and second laths 130, 140, and/or the distance member 160 comprise lignocellulosic fibres.

Depending on what material is used for the sheets 110, 120 and the laths 130, 140, the density of sharp projections 175 (i.e. projections/inch²) may be adjusted to fit different materials. For instance, the density of sharp projections 175 may be between 10 and 50 projections/inch² (i.e. about 150 to 770 projections/dm²), preferably between 15 and 25 projections/inch² (i.e. about 230 to 380 projections/dm²) and most preferred about 22 projections/inch² (i.e. about 340 projections/dm²). A too high density of sharp projections 175 results in a too high forces when pressing the materials together, i.e. the first and second sheets 110, 120, and the first and second laths 130, 140 (preferably formed from a wood fibre material) will not withstand this high forces during the pressing. A too low density of sharp projections will not be able to withstand shearing forces in the hollow board material 100.

Properties such as thickness and hardness of the sheets and laths affect the density requirements. Hence, the arrangement of the sharp projections 175 on the two faces 171, 172 of the double-faced metal gripping lamina 170 may differ between the two faces 171, 172. Preferably, the density/pattern of the sharp projections 175 on a face configured to penetrate a particle board material differs from the pattern applied on a face configured to penetrate an HDF/MDF board. In such case, the particle board material comprises fewer sharp projections 175 than the HDF/MDF board.

Furthermore, the appearance of the projections 175 may be adjusted by varying the width of their base 177 and how straight or crooked the tip 178 is to enhance fastening properties between the laths 130, 140 and the sheets 110, 120. A wider base 177 and a substantially straight, i.e. non-curved, projection facilitates the penetration of the sharp projection 175 into wood and wood boards.

FIG. 3d shows a slightly curved sharp projection 175. A vertical line indicates a threshold of an acceptable curvature of the sharp projection 175. The threshold is a base plate line 179 extending perpendicular from the base of the sharp projection 175 and the first face 171 of the metal gripping lamina 170 in a vertical direction. The base plate line intersects the metal plate 176 where an outer surface of the base 177 (i.e. the surface of the base 177 not facing the groove 174) and the metal plate 176 coincide. Since the tip 178 does not extend beyond the base plate line, as shown in FIG. 3d, the curvature of the sharp projection 178 is satisfactory and the curvature still enables the penetration of the sharp projections 175 into the sheets 110, 120 and the laths 130, 140.

If the tip 178 of the sharp projection 175 is curved beyond the base plate line 179, as shown in FIG. 3e, the sharp projection 175 is too crooked, which poses a risk that the curved sharp projections 175 will have difficulties penetrating into the laths 130, 140 or the sheets 110, 120. In turn, this may cause the too curved sharp projections 175 to rupture and act as a blockage such that a tight fit between the laths 130, 140 and the sheets 110, 120 cannot be obtained. By using of the metal gripping lamina 170 instead of a conventional adhesive, a hollow board material 100 having improved strength and solidity is obtained. The metal gripping lamina 170 provides rigidity and stability to the hollow board material 100. It also ensures that the board withstands humid environments without disintegrating. As will be described more in detail in the following, the method for assembling the hollow board material 100 disclosed herein is easy and a quick process. Further, the need for toxic or hazardous adhesives or chemicals is significantly reduced.

To enhance rigidity of a hollow board material, the skilled person may consider adding a thin metal plate between said laths and said sheets. Such metal plate could be adhered through the use of a glue. This would however require de-oxidizing the metal surface just before applying the glue and attaching the metal plate to the laths and the sheet, resulting in a narrow time frame for the application of the metal plates. Further, also a washing step is necessary. Hence, this option is not preferable.

Most glues, which are cheap and easy to work with, are thermoplastic glues and many time waterborne. This in turn inevitably results in a creep in the glue line. Hence, the waterborne glue will in due time dissolve into the board material. This will weaken the connection of the sheets 110, 120 to the laths 130, 140 and eventually it will be lost. Humidity will speed up the creep and shorten the lifetime of board material 100.

The sharp projections 175 on the metal gripping lamina 170 penetrate the sheets 110, 120 and the laths 130, 140 in the hollow board material 100, for instance at a depth of 1.4 mm. The metal gripping lamina 170 is not subject to any substantial creep.

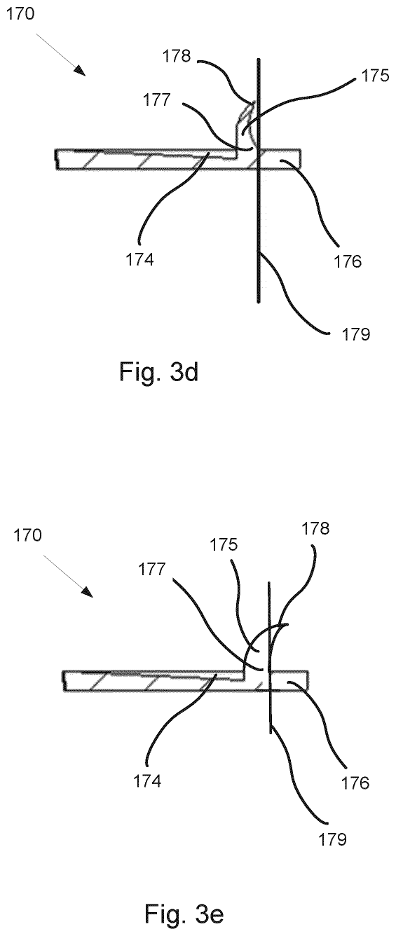

FIG. 4 shows another embodiment of the hollow board material 200. In FIG. 4, a side view from the same perspective as section A-A of the board 100 from FIG. 1 is shown. However, the cross-section of the lath 230 has another shape than that shown in FIG. 2a (the lath 130 of FIG. 2a has a rectangular cross-section) to allow for attachment of the lath 230 to the sheets 210, 220 using both the metal gripping element 270 and an adhesive 290. The lath 230 is thus provided with two recesses 231 extending along the longitudinal extension of the lath on opposite sides for receiving the metal gripping material 270.

The two recesses 231 extending along the longitudinal extension of the lath may be centrally arranged with elevations 235 on each side. Thus, the lath 230 may have an H-shaped cross section, forming two recesses 231 configured to receive the metal gripping material 270.

The depth of the recesses 231 is typically 0.8 to 1.2 times the thickness of the metal gripping material 270. Preferably, the depth of the recesses 231 is about the same as the thickness of the metal gripping material 270. To enhance the strength of the hollow board material 200 further, this embodiment provides for attachment of the lath 230 to the sheets 210, 220 using both the metal gripping element 270 and an adhesive 290. The four elevations 235 are in direct contact with the sheets 210, 220 and are fastened to each other with an adhesive, 290, such as glue. An edge band 250 is attached to the edge 201 of the hollow board material 200.

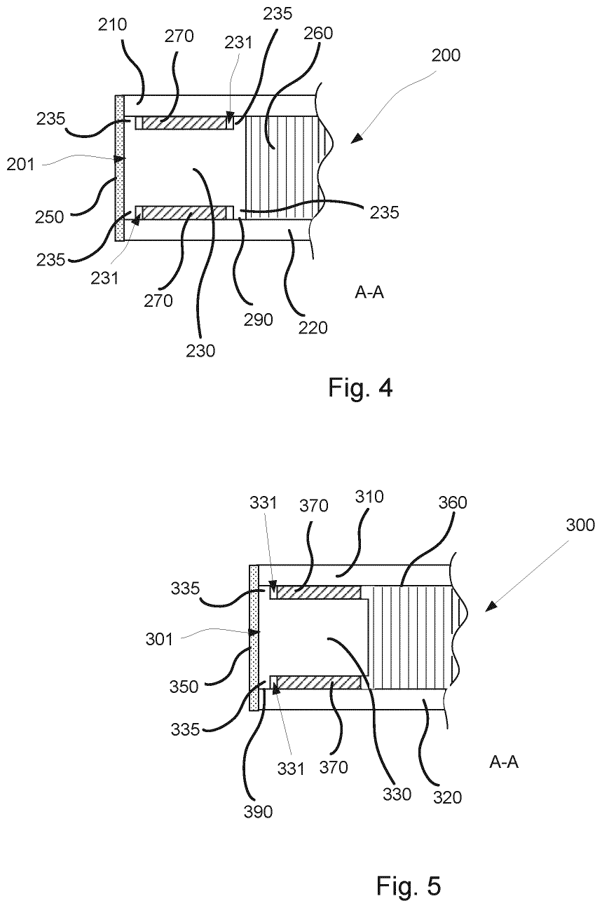

With reference to FIG. 5, a variant of the embodiment of the hollow board material 300 in FIG. 4 is shown. The lath 330 shown in FIG. 5 has a T-shaped cross-section, rather than an H-shaped cross-section. Also this configuration of the lath 330 allows for the use of the metal gripping lamina 370 as well as glue 390, as two elevations 335 are in direct contact with the sheets 310, 320. The lath 330 is provided with two recesses 331 receiving the metal gripping lamina 370. The two recesses 331 extend longitudinally along opposite sides of the lath 330 with the elevations 335 only on one side. Similar to the recesses 231, the depth of the recesses 331 may be 0.8 to 1.2 times the thickness of the metal gripping material 270. Preferably, the depth of the recesses 331 is about the same as the thickness of the metal gripping material 370. An edge band 350 is attached to the edge 301 of the hollow board material 300.

The metal gripping lamina 270, 370 and the distance material 260, 360 of the embodiments shown in FIGS. 4 and 5 are configured in the same manner as described with reference to FIGS. 2a to 3c.

The hollow board material 100 is assembled by placing two separate metal gripping laminas 170 between the first sheet 110 and the first lath 130 and the first sheet 110 and the second lath 140. The two laths 130, 140 are placed in parallel to each other on the first sheet 110 such that said laths 130, 140 extends along two opposite edges of the first sheet 110.

To secure the fastening of the laths 130, 140 to the first sheet 100, a light pressure is applied to push the protrusions 175 of the metal gripping lamina 170 into the laths 130, 140 and first sheet 110 respectively. The distance material 160 is placed between the two laths 130, 140, and the procedure of attaching the two laths 130, 140 to the second sheet 120 is performed in the same manner as described above. Namely, two separate metal gripping laminas 170 are arranged between the first lath 130 and the second sheet 120 and the second lath 140 and the second sheet 120 respectively. The metal gripping laminas 170 are placed such that a space 180 is obtained between the outermost edges of the laths 130, 140 and the sheets 110, 120, and the metal gripping lamina 170, as shown in FIGS. 2a and 2b.

Subsequently, pressure is applied to push the protrusions 175 of the metal gripping laminas 170 into the laths 130, 140 and second sheet 120 respectively to securely fasten the second sheet 120 to the laths 130, 140.

Optionally, the distance material 160 is placed in between the two laths 130, 140 before placing two separate metal gripping laminas 170 between the first sheet 110 and the first lath 130 and the first sheet 110 and the second lath 140.

The pressure used is sufficiently high to press the sharp projections 175 into the laths 130, 140 and sheets 110, 120 respectively, while not breaking or affecting the remaining parts of the hollow board material 100 negatively. The pressure applied should provide maximum adhesion without damaging the hollow board material 100. For instance, a veneer press applying a pressure of about 250 bar can be used to press the sharp projections into the laths and sheets respectively.

The metal gripping lamina 170 may also be used if the laths 130, 140 are present as a frame extending around the edges of the hollow board material 100. In such case, the metal gripping lamina 170 is arranged between the frame and the first sheet 110 and the second sheet 120 in the hollow board material 100 (not shown).

Finally, the edges 101 of the formed hollow board material 100 are milled or cut to obtain a preferred shape, and the edge bands 150 are attached to the edges 101 of the hollow board material 100. Said edge bands 150 are preferably attached using an adhesive, such as a glue.

Optionally, the metal gripping lamina 170 may be embedded into the raw materials for forming the laths 130, 140 and the sheets 110, 120 before the laths 130, 140 and sheets 110, 120 are formed. The raw materials are placed in the desired position between the materials to be formed into laths 13, 140 or sheets 110, 120 and are subsequently pressed together such that adhesion between the formed laths 130, 140 and the sheets 110, 120 is obtained using the metal gripping lamina 170. In such case, the sharp projections 175 may have a greater curvature and have a more hook-like appearance. This will contribute to a secure and strong fastening between the sheets 110, 120 and the laths 130, 140 since the hook-like tip 178 will engage the materials in the laths 130, 140 and the sheets 110, 120 and thus be prevented from being retracted therefrom. For instance, the sharp projections 175 may be curved to such extent that the tip 178 extends beyond the base plate line as shown in FIG. 3e.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different than those described above.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an” “first”, “second” etc. do not preclude a plurality.

1. A hollow board material comprising a first sheet and a second sheet,
wherein a first lath and a second lath are arranged in parallel between the first sheet and the second sheet along opposite edges of the hollow board material, the first lath and a second lath being attached to the first sheet and the second sheet,
wherein the first lath and the first sheet are attached to each other by means of a first metal gripping lamina at least partly covering said first lath, and wherein the second lath and the first sheet are attached to each other by means of a second metal gripping lamina at least partly covering said first lath;
optionally the first lath and the second sheet being attached to each other by means of a third metal gripping lamina and optionally the second lath and the second sheet being attached to each other by means of a fourth metal gripping lamina,
the metal gripping laminas having a first face and a second face being opposed to each other, each face comprising a plurality of sharp projections extending substantially perpendicular therefrom and into the laths or the sheets, respectively, the metal gripping laminas thereby providing a hollow board material (100) and increasing the bending strength of said hollow board material.

2. The hollow board material according to claim 1, wherein a height of the sharp projections is smaller than a thickness of the first and second sheets.

3. The hollow board material according to claim 1, wherein the sharp projections are gouged from the first and second face of the metal gripping laminas.

4. The hollow board material according to claim 1, wherein the sharp projections of the metal gripping lamina are arranged in rows on said first and second faces.

5. The hollow board material according to claim 4, wherein the sharp projections in rows adjacent to each other are gouged from opposite angles, the sharp projections being gouged parallel to the longitudinal extension of the metal gripping laminas.

6. The hollow board material according to claim 1, wherein the metal gripping lamina is between 0.2 mm and 3 mm thick.

7. The hollow board material according to claim 1, wherein
the first and second sheets comprises lignocellulosic fibres; and/or
the first and second laths comprises lignocellulosic fibres.

8. The hollow board material according to claim 7, wherein
the first and second sheets are sheets of a particle board, or fibreboard; and/or
the first and second laths are laths of a particle board, chip board, or fibreboard.

9. The hollow board material according to claim 1, wherein the hollow board material further comprises a third lath and a fourth lath arranged perpendicular to said first lath and second lath, along edges of the first and second sheets, whereby the first, second, third and fourth laths form a frame surrounding the edges of the hollow board material.

10. The hollow board material according to claim 1, further comprising a distance member being arranged between and attached to the first sheet and the second sheet.

11. The hollow board material according to claim 10, wherein the distance member comprises lignocellulosic fibres.

12. The hollow board material according to claim 11, wherein the distance member is a distance member of a paper board, particle board, or fibreboard.

13. The hollow board material according to claim 10, wherein the distance material are strips arranged perpendicular to the extension of the first and second sheets, the strips being attached to the first and second sheet (110, 120) by means of an adhesive.

14. The hollow board material according to claim 1, wherein at least one lath is provided with a recess in which the metal gripping lamina is arranged.

15. A furniture comprising a hollow board material according to claim 1.

16. A method for manufacturing a hollow board material, said method comprising the steps of:
(i) arranging two laths in parallel to each other on a first sheet, such that said laths are extending along two opposite edges of the first sheet, wherein metal gripping laminas are arranged between the two laths and the first sheet;
(ii) arranging a second sheet on the laths, wherein metal gripping laminas (170) optionally are arranged between the two laths and the second sheet; and
(iii) applying a pressure along the edges of the hollow board member where the laths are arranged, whereby the metal gripping lamina(s) securely fasten the laths and the sheets together.

17. The method according to claim 16, wherein before step (ii), a distance material is placed in between the two laths.

18. The method according to claim 16, wherein after step (iii), at least one edge band is attached to an edge of the hollow board material, preferably the edge band (150) being attached using an adhesive.

19. The hollow board material according to claim 8, wherein
the first and second sheets are sheets of HDF; and/or
the first and second laths are laths of chip board or fibreboard.

20. The hollow board material according to claim 13, wherein the strips are arranged in a meandering pattern, or as a honeycomb structure, and wherein the distance member is a distance member of card board.
